(19) United States
(12) Patent Application Publication
(10) Pub. No.: US 2025/0166446 A1
(43) Pub. Date: May 22, 2025

(54) METHOD, DEVICE AND SYSTEM FOR CATERING PREPARATION

(71) Applicant: Beijing ZEEWAY-Technology Ltd, Beijing (CN)

(72) Inventors: Mengyi Zhu, Beijing (CN); Fumei Duan, Beijing (CN); Renlong Zhang, Beijing (CN); Haijin Xu, Beijing (CN); Musheng Shen, Beijing (CN); Yunlong Xu, Beijing (CN)

(73) Assignee: Beijing ZEEWAY-Technology Ltd, Beijing (CN)

(21) Appl. No.: 18/955,949

(22) Filed: Nov. 21, 2024

(30) Foreign Application Priority Data
Nov. 22, 2023 (CN) 202311566488X

(51) Int. Cl. G07F 13/06; G05B 13/02

(52) U.S. Cl. CPC G07F 13/065; G05B 13/02

(57) ABSTRACT

The present invention discloses a method for catering preparation, comprising: providing raw material bins of a device for catering preparation corresponding to codes of raw materials, and filling each of the bins with the corresponding raw material; the device for catering preparation receives orders, each of which includes a name and quantity of a food or a beverage; the device for catering preparation parses each of the orders, the device for catering preparation drives a driving device of the raw material bin corresponding to the code of each of the raw materials and its quantity required, to dispense the quantity of the raw material. The invention also discloses a device and a system for catering preparation. The present invention directly corresponds the names of foods or beverages to the codes and quantities of materials required, parsing order simply and accurately, facilitating development and implementation of various recipes, and also aiding in management of required raw materials.

### TECHNICAL FIELD

The present invention relates to field of catering automation, and more specifically, to catering preparation methods. The present invention also relates to catering preparation device and system.

### BACKGROUND

In today's era of rapid technological advancement, the decline in machine costs combined with the rise in labor costs has led to the gradual emergence of catering automation. Catering automation is an emerging field, and various automated catering methods and equipment, such as automatic beverage dispensing and meal assembly, have already emerged. However, the level of automation and diversity of catering configuration methods, equipment, or systems still need to be improved.

Therefore, there is a need for more scientific and effective configuration methods, equipment, and systems suitable for catering automation.

### SUMMARY

The purpose of the present invention is to solve or at least partially alleviate the above-mentioned problems by providing a method, device and a system for catering preparation.

According to one aspect of the present invention, there is provided a method for catering method comprising:
providing raw material bins of a device for catering preparation corresponding to codes of raw materials, and filling each of the bins with the corresponding raw material;
the device for catering preparation receives orders, each of which includes a name and a quantity of a food or a beverage;
the device for catering preparation parses each of the orders,
the device for catering preparation drives a driving device of the raw material bin corresponding to the code of each of the raw materials and its quantity required, to dispense the quantity of the raw material.

Preferably, the order further includes preparation modes, capacity specifications, and sweetness levels, and when parsing the order, the device for catering preparation further obtains the codes and quantities of required raw materials that correspond to the name of the food or beverage according to the preparation modes, capacity specifications, and sweetness levels.

Preferably, the preparation modes include cold preparation and hot preparation, the capacity specifications include large, medium, or small cup, and the sweetness levels include standard sugar, half of standard sugar, seventy percent of standard sugar, or thirty percent of standard sugar.

Preferably, the device for catering preparation firstly determines a container for holding the beverage or food according to operation modes and capacity specifications before driving the driving devices of the raw material bins, and then combining with the preparation mode and sweetness level, obtains the codes and quantities of raw materials codes required for the food or beverage name under the corresponding preparation mode and sweetness level.

Preferably, if there are raw materials required by the name of the food or beverage corresponds without corresponding raw material bins, those raw materials are determined to be dispensed by manual operation.

Preferably, the device for catering preparation includes an upper computer and a lower computer, and the method further comprises the following steps: after parsing the order, sending the codes and quantities of the raw materials corresponding to the food or beverage name to the upper computer, which sends driving instructions for the driving devices of each material bin corresponding to codes of the raw material to the lower computer, and the lower computer drives the driving devices of the material bins according to the driving instructions to dispense the corresponding quantities of raw materials.

Preferably, the device for catering preparation is connected to a cloud platform, and receives orders through an order management system that is connected to both it and the cloud platform, and wherein the order management system parses the order by accessing the cloud platform, where the food or beverage names and corresponding codes and quantities of raw material are provided.

Preferably, the cloud platform is also provided with status information for the device for catering preparation, and after the lower computer receives the driving instructions and completes the instructions, it sends a receipt back to the upper computer, which requests the cloud platform to change working status, and the cloud platform changes the status of the device for catering preparation to “in progress” or “completed,” and this status information is then distributed by the cloud platform to the upper computer.

Preferably, the cloud platform also has a recipe database, which includes recipes corresponding to the food and beverage names, where the recipes correspond the food and beverage names to the required raw material codes and quantities.

According to another aspect of the present invention, there is provided a device for catering preparation, comprising:
Material bins for holding raw materials, with the bins corresponding to code of the raw materials;
Wherein the device for catering preparation includes or is connected to an order management system, which receives orders that include food or beverage names and quantities, parses each order to correspond the food or beverage names with the required codes and quantities of raw materials required, and wherein the device for catering preparation drives the driving devices of the material bins corresponding to the codes and quantities of the raw materials required to dispense the corresponding quantities of the raw materials.

Preferably, the device for catering preparation further comprises: an upper computer and a lower computer, wherein the upper computer receives the codes and quantities of raw materials corresponding to the food or beverage names sent by the order management system, and sends driving instructions to the lower computer to drive the driving device of each of material bins corresponding to the codes of raw materials, and wherein the lower computer drives the driving devices of the material bins according to the driving instructions to dispense the corresponding quantities of raw materials.

Preferably, the order management system is connected to the device for catering preparation via a cloud platform, and corresponds the beverage name to each of the codes and quantities of the raw materials required, and sends codes and quantities of raw materials to the upper computer of the device for catering preparation through the cloud platform.

Preferably, the lower computer sends a receipt back to the upper computer after receiving and completing the drive instructions and wherein the upper computer sends the working status of the device of catering preparation to the cloud platform.

According to another aspect of the present invention, there is provided a system for catering preparation, comprising:
A cloud platform;
A device for catering preparation, connected to the cloud platform, comprising material bins for holding raw materials, with each of the material bins corresponding to one of codes of the raw materials;
An order management system, provided in the device for catering preparation or connected to both of the cloud platform and the device for catering preparation, for receiving orders that include a beverage or a food name and a quantity,
Wherein the order management system corresponds the beverage name or the food name in the order to the codes and quantities of the raw materials required, and distributes the codes and the quantities of the raw materials to the device for catering preparation, and wherein the device for catering preparation sequentially drives each of the driving devices of the material bins corresponding to one of the codes of the raw materials and dispenses the corresponding quantity of raw material.

Preferably, the cloud platform comprises a recipe management database for being input the names of the beverages or foods and corresponding recipes, and wherein each of the recipes comprises codes and quantities of the raw materials required.

The method, device and system for catering preparation can parse orders simply and correctly, and are convenient for development and realization of many kinds of beverages and foods and recipes, and also convenient for management for required raw materials.

### BRIEF DESCRIPTION OF FIGURES

Other features, objectives, and advantages of the present invention will become more apparent by reading the detailed description of non-limiting embodiments with reference to the following figures:

FIG. 1 is a flowchart illustrating principles of a method for catering preparation according to the present invention.

FIG. 2 is a block diagram of an embodiment of a device for catering preparation according to the present invention.

FIG. 3 is a block diagram of an embodiment of a system for catering preparation according to the present invention.

FIG. 4 is a flowchart of an embodiment of the method for catering preparation according to the present invention.

FIG. 5 is a flowchart of another embodiment of the method for catering preparation according to the present invention.

### DETAILED EMBODIMENTS

The following provides a more detailed explanation of the present application in conjunction with the accompanying drawings and embodiments. It should be understood that the specific embodiments described here are for purpose of explaining the relevant invention and are not intended to limit the invention. Additionally, for sake of clarity, only parts relevant to the invention are shown in the drawings.

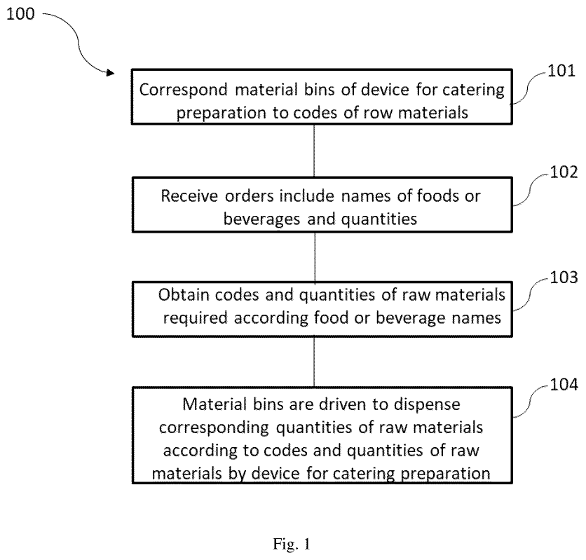

FIG. 1 is a flowchart illustrating principles of a method for catering preparation according to the present invention, which is generally indicated by a reference number 100, and includes steps 101, 102, 103, and 104. In step 101, material bins of a device for catering preparation are correspondingly set with codes of the raw materials, and each of the material bins stores the corresponding raw material. In step 102, the device for catering preparation receives orders, each of which includes a name and quantity of a food or a beverage. In step 103, the device for catering preparation parses each of the orders, and correlates the name of the food or the beverage with codes and quantities of raw materials required. In step 104, the device for catering preparation sequentially drives a driving device of the raw material bin corresponding to the code of each of the raw materials and its quantity required, to dispense the corresponding quantity of the raw material.

The catering configuration method of the present invention correlates the dish name with the raw material codes and quantities needed, where the raw material codes correspond one-to-one with the material bins of the catering configuration equipment. This makes the order parsing direct, simple, and accurate, facilitating the development and implementation of various dishes and recipes, while also aiding in the management of required raw materials.

The order may also include preparation modes, capacity specifications, and sweetness levels. In step 103, when the device for catering preparation parses the order, it further obtains the codes and quantities of the raw materials corresponding to the name of the food or the beverage based on the preparation modes, the capacity specifications, and sweetness levels. For example, the preparation modes include cold and hot preparation modes, the capacity specifications include large, medium, or small cup, and the sweetness levels include standard sugar, half of the standard sugar, seventy percent of the standard sugar, or thirty percent of the standard sugar. Different capacity specifications require different quantities of raw materials, and different sweetness levels require different quantities of added sugar. The cold preparation mode may include ice added, extra ice, less ice, ice slush added, or not heating, while the hot preparation mode may include hot beverages or hot foods.

Before step 104, that is, before the device for catering preparation drives the driving devices of the material bins, the method for catering preparation 100 firstly determines a container for holding the beverage or food according to the preparation modes (operation modes) and capacity specifications. It then combining with the preparation mode (operation mode) and the sweetness level, obtains the codes and quantities of the raw materials codes required for the food or beverage name under the corresponding preparation mode and sweetness level. If there are raw materials required by the name of the food or beverage without corresponding raw material bins, those raw materials are determined to be dispensed by manual operation. For example, when preparing bubble teas, some bubble teas require a milk cap, which the device for catering preparation is not able to dispense automatically raw materials using the driving devices of the material bins. In this case, each of the corresponding raw materials is dispensed by manual operation and will be added to the container manually after all steps of other raw materials automatically dispensed completed.

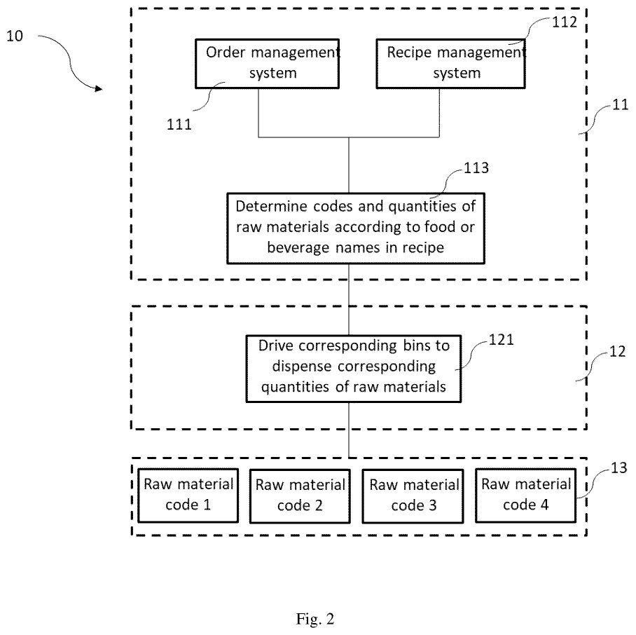

FIG. 2 is a block diagram of an embodiment of a device for catering preparation according to the present invention. The device in separate status for catering preparation is generally designated by reference number 10 is illustrated in FIG. 2, which implements the method for catering preparation described in FIG. 1.

Specifically, as shown in the figure, the device for catering preparation 10 includes a upper computer 11, a lower computer 12, and a material bin 13. In this separate device, the upper computer 11 comprises an order management system 111 and a recipe management system 112. The order management system 111 receives orders that include names of beverages or foods, quantities, and other details, while the recipe management system 112 is used to set up recipes corresponding to the names of the beverages or foods. These recipes include codes and quantities of raw materials that correspond to the raw materials. The materials in the material bins 13 are provided to correspond one-to-one with the codes of the raw materials.

When executing the method for catering preparation 100 shown in FIG. 1, the separate device for catering preparation 10 of this embodiment receives orders that include the names of the beverages or foods, quantities, and other details through the order management system 111. The upper computer 11 performs step 113, matching the received orders with recipes in the recipe management system 112 through order parsing, obtaining the codes and quantities of the required raw materials. It then sends a driving instruction for a driving device corresponding to each raw material code to the lower computer 12. The lower computer 12 then executes step 121, driving the driving devices of the material bins 13 according to the driving instructions to dispense the corresponding quantity of the raw materials.

The separate device for catering preparation shown in FIG. 2 can also have the recipe management system set up on a cloud platform, with the device for catering preparation connected to the cloud platform in charge of recipe management and equipment management.

Moreover, the separate device for catering preparation can further place both the order management system and the recipe management system on the cloud platform, with the device for catering preparation connected to the cloud platform in charge of order management, recipe management, and equipment management.

In this case, the device for catering preparation only needs to set up the material bins corresponding to the codes of the raw materials. The order management system on the cloud platform receives orders that include the names of the beverages or foods, and quantity, performs order parsing on the cloud, and corresponds the names of the beverages or foods to the codes and quantities of the required raw materials. It then sends the codes and quantities of the raw materials required to prepare the beverage or food with the name of the beverage or food back to the upper computer of the device for catering preparation. The upper computer generates a driving instruction corresponding to a material bin for each of raw material codes according to the codes and quantities of raw materials received and sends the instruction to the lower computer. The lower computer then drives the driving device of the material bin corresponding to each of the codes of raw materials according to the driving instruction to dispense the corresponding quantities of raw materials.

After receiving the driving instructions and completion commands, the lower computer sends receipts back to the upper computer. The lower computer then sends operation status of the device for catering preparation to the cloud platform according to the receipts, and hence the cloud platform is able to monitor and manage the device for catering preparation.

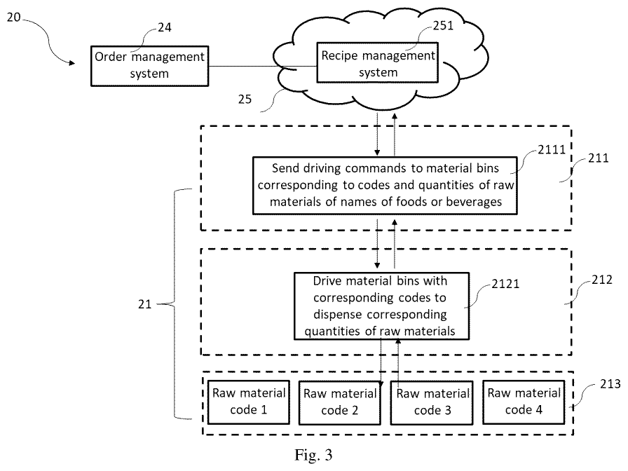

FIG. 3 is a block diagram of an embodiment of a system for catering preparation according to the present invention. The system for catering preparation shown in FIG. 3 implements the method catering preparation described in FIG. 1, and is generally indicated by reference number 20.

The system for catering preparation 20 shown in FIG. 3 includes a cloud platform 25, a device for catering preparation 21 connected to the cloud platform 25, and an order management system 24 connected to the cloud platform 25. The order management system 24 is responsible for receiving orders that include names and quantities of beverages or foods. The cloud platform 25 includes a recipe management database 251 for being input the names and their corresponding recipes, which comprise codes and quantities of various raw materials required to prepare the beverages or foods. The device for catering preparation 21 includes a upper computer 211, a lower computer 212, and raw material bins 213. Each of the raw material bins 213 is used to hold the corresponding raw material, with each raw material bin corresponding to each of the codes of the raw materials.

The order management system 24 and the recipe management system 25 correspond to the codes and quantities of the required materials by beverage or food names in the orders, and sends this information to the upper computer 211 of the device for catering preparation. The upper computer 211 performs step 2111, receiving the codes and quantities of the materials corresponding to the beverage or food names from the order management system, and sends driving commands to the driving devices of the corresponding material bins. The lower computer 212 performs step 2121 by driving the driving devices of the material bins according to the drive commands to dispense the corresponding quantities of materials.

The system for catering preparation of the present invention may also only comprise the cloud platform and the device for catering preparation, wherein the cloud platform is provided a recipe management system. The order management system is an outsourced one compatible with the cloud platform.

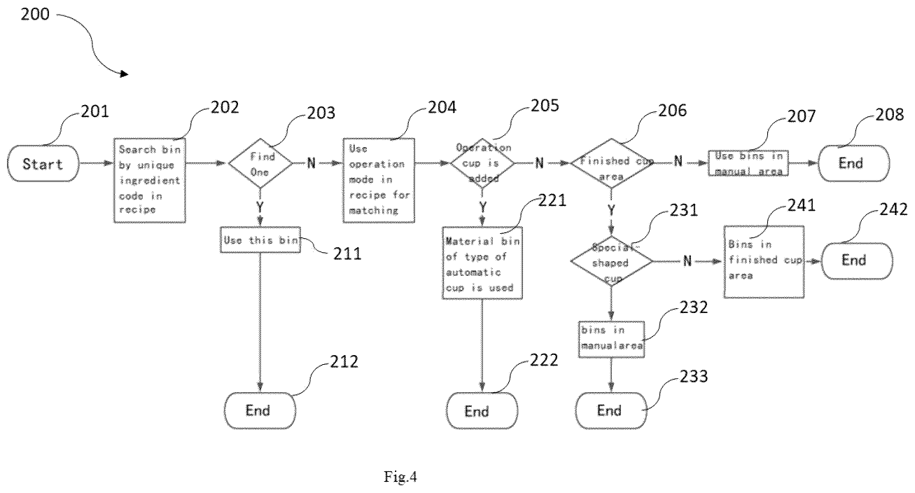

FIG. 4 is a flowchart of an embodiment of the method for catering preparation according to the present invention. The method for catering preparation of this embodiment is generally indicated by a reference number 200, starting from step 201. In step 202, the unique codes of the raw materials in the recipe are used to look up the material bins, and in step 203, it is determined whether the material bins have been found. If the material bins are found, step 211 is performed to confirm use of these bins and to drive the bins to dispense the required quantities of raw materials, continuing until step 212, wherein the method ends after all material bins required have dispensed the required quantities.

It should be noted that before start of step 201, specifications have been determined based on the order, specifically specifications for containers for holding beverages, thus allowing for determination of the quantities of the materials corresponding to the containers.

Due to complexity of preparation for beverages or foods, there may be raw materials in the catering preparation process that cannot be automatically dispensed, that is there are no material bins corresponding to the codes of the materials. In this case, step 204 uses the operation mode (preparation mode) in the recipe for matching. In step 205, it is determined whether an operation cup should be added. Whether an operation cup is added means that whether the beverage can be prepared automatically. If yes, then step 221 is performed, wherein a material bin of type of automatic cup is used automatically for preparation until the raw materials of the similar types are dispensed, and the process goes to step 222 wherein the dispensing of the materials is ended. If result in step 205 is no, the process continues to go to step 206, determining whether there is a finished cup area for the device. The term “finished cup area” means whether the step has produced a final product. If yes, step 231 is performed to determine if a special-shaped cup is needed. If result of it is no, the operation cup is used as a final cup, and the process goes to step 241, and further goes to step 242, wherein the catering preparation is completed. If result of it is yes, step 232 is performed to go to material bins in manual area, where a manual cup is changed to a special-shaped cup, and the process goes to step 233 to complete the catering preparation. If in step 206, it is determined that a final product is not completed, step 207 is executed, wherein the required materials are manually added to the material bins in the manual area, then the process goes to step 208, wherein the catering preparation is completed.

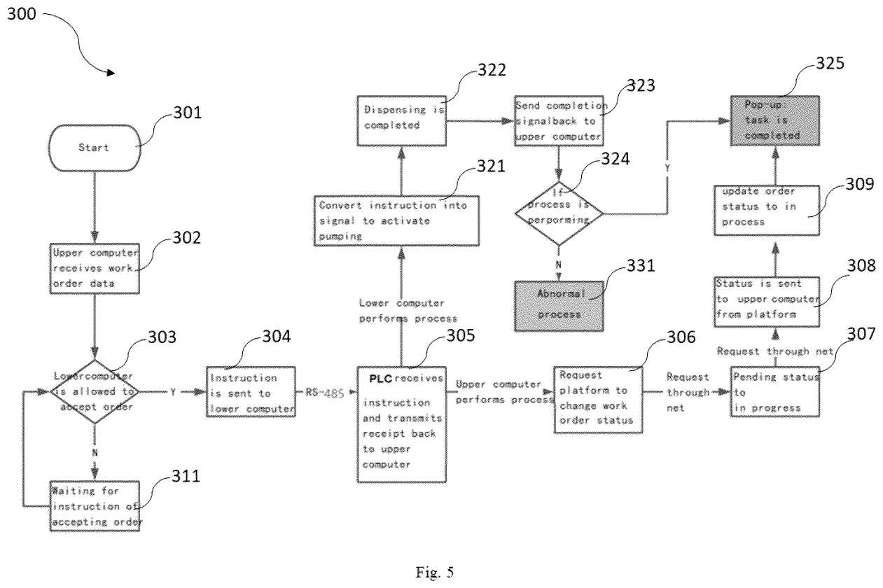

FIG. 5 is a flowchart of another embodiment of the method for catering preparation according to the present invention. The method for food and beverage preparation of this embodiment is generally indicated by reference number 300, starting from step 301, and then going to step 302, wherein the upper computer receives work order data, namely codes and quantities of the raw materials. Next, the process goes to step 303, the lower computer determines whether it is allowed to accept the order. If the lower computer is busy, in malfunctioning, or in cleaning mode, it proceeds to step 311, waiting for an instruction of accepting an order. If the lower computer is in a normal status and can accept orders, it goes to step 304, wherein it sends instructions to dispense required quantities of the raw materials from the designated storage based on the raw material codes to the lower computer. The lower computer then sends the instruction to the driving device in step 305, wherein the driving device receives the instruction and transmits a receipt back to the upper computer. Following this step, the lower computer executes step 321, converting the instruction into a signal to activate pumping of the materials, and then proceeds to step 322, wherein the required quantities of the raw materials are pumped out and the dispensing is completed. After that, in step 323, it sends a completion signal back to the upper computer. In step 324, the upper computer determines whether the process is normal, and if it is normal, it proceeds to step 325, displaying a completion pop-up. If there is an anomaly, it shows an abnormal process and uploads the decision to the cloud platform. After step 305, the upper computer moves to step 306, requesting the cloud platform to change the work order status. In step 307, the cloud platform changes the previous pending execution status of the work order to “in progress”. Then in step 308, the cloud platform sends the updated status back to the upper computer. In step 309, after receiving this status, the upper computer updates status of the work order to “in progress” and it proceeds to step 325, displaying that the task is completed.

The method for catering preparation of the present invention is not limited to the specific steps shown in FIGS. 4 and 5, but any steps can be added, deleted, or combined. All steps that implement steps according to flow of raw materials of the method for catering preparation are within scope of protection of the present invention.

The present invention also relates to computing devices on which a computer program is installed, which, when executed, carries out the food and beverage configuration method according to the present invention.

Additionally, the present invention involves computer-readable storage media storing a computer program that, when executed by a computer, implements the food and beverage configuration method according to the present invention.

The above description merely involves preferred embodiments of this application and an explanation of technical principles employed. Those skilled in the art should understand that the scope of the invention involved in this application is not limited to the specific combinations of the technical features described above, but also encompasses other technical solutions formed by any combination of the aforementioned technical features or their equivalents without departing from the inventive concept described. For example, technical solutions formed by substituting the above features with other technical features disclosed in this application that have similar functions (but are not limited to them) are also included.

What is claimed is:

1. A method for catering preparation, comprising:
providing raw material bins of a device for catering preparation corresponding to codes of raw materials, and filling each of the bins with the corresponding raw material;
the device for catering preparation receives orders, each of which includes a name and quantity of a food or a beverage;
the device for catering preparation parses each of the orders,
the device for catering preparation drives a driving device of the raw material bin corresponding to the code of each of the raw materials and its quantity required, to dispense the quantity of the raw material.

2. The method for catering preparation according to claim 1, wherein the order further includes preparation modes, capacity specifications, and sweetness levels, and when parsing the order, the device for catering preparation further obtains the codes and quantities of required raw materials that correspond to the name of the food or beverage according to the preparation modes, capacity specifications, and sweetness levels.

3. The method for catering preparation according to claim 2, wherein the preparation modes include cold preparation mode and hot preparation mode, the capacity specifications include large, medium, or small cup, and the sweetness levels include standard sugar, half of standard sugar, seventy percent of standard sugar, or thirty percent of standard sugar.

4. The method for catering preparation according to claim 2, wherein the device for catering preparation firstly determines a container for holding the beverage or food according to operation modes and capacity specifications before driving the driving devices of the raw material bins, and then combining with the preparation mode and sweetness level, obtains the codes and quantities of raw materials codes required for the food or beverage name under the corresponding preparation mode and sweetness level.

5. The method for catering preparation according to claim 1, wherein if there are raw materials required by the name of the food or beverage without corresponding raw material bins, those raw materials are determined to be dispensed by manual operation.

6. The method for catering preparation according to claim 1, wherein the device for catering preparation includes an upper computer and a lower computer, and the method further comprises the following steps: after parsing the order, sending the codes and quantities of the raw materials corresponding to the food or beverage name to the upper computer, which sends driving instructions for the driving devices of each material bin corresponding to codes of the raw material to the lower computer, and the lower computer drives the driving devices of the material bins according to the driving instructions to dispense the corresponding quantities of raw materials.

7. The method for catering preparation according to claim 6, wherein the device for catering preparation is connected to a cloud platform, and receives orders through an order management system that is connected to both it and the cloud platform, and wherein the order management system parses the order by accessing the cloud platform, where the food or beverage names and corresponding codes and quantities of raw material are provided.

8. The method for catering preparation according to claim 7, wherein the cloud platform is also provided with status information for the device for catering preparation, and after the lower computer receives the driving instructions and completes the instructions, it sends a receipt back to the upper computer, which requests the cloud platform to change working status, and the cloud platform changes the status of the device for catering preparation to “in progress” or “completed,” and this status information is then distributed by the cloud platform to the upper computer.

9. The method for catering preparation according to claim 8, wherein the cloud platform also has a recipe database, which includes recipes corresponding to the food and beverage names, where the recipes correspond the food and beverage names to the required raw material codes and quantities.

10. A device for catering preparation, comprising:
Material bins for holding raw materials, with the bins corresponding to code of the raw materials;
Wherein the device for catering preparation includes or is connected to an order management system, which receives orders that include food or beverage names and quantities, parses each order to correspond the food or beverage names with the required codes and quantities of raw materials required, and wherein the device for catering preparation drives the driving devices of the material bins corresponding to the codes and quantities of the raw materials required to dispense the corresponding quantities of the raw materials.

11. The device for catering preparation according to claim 10, further comprising: an upper computer and a lower computer, wherein the upper computer receives the codes and quantities of raw materials corresponding to the food or beverage names sent by the order management system, and sends driving instructions to the lower computer to drive the driving device of each of material bins corresponding to the codes of raw materials, and wherein the lower computer drives the driving devices of the material bins according to the driving instructions to dispense the corresponding quantities of raw materials.

12. The device for catering preparation device according to claim 11, wherein the order management system is connected to the device for catering preparation via a cloud platform, and corresponds the beverage name to each of the codes and quantities of the raw materials required, and sends codes and quantities of raw materials to the upper computer of the device for catering preparation through the cloud platform.

13. The device for catering preparation according to claim 11, wherein the lower computer sends a receipt back to the upper computer after receiving and completing the drive instructions and wherein the upper computer sends the working status of the device of catering preparation to the cloud platform.

14. A system for catering preparation, comprising:
A cloud platform;
A device for catering preparation, connected to the cloud platform, comprising material bins for holding raw materials, with each of the material bins corresponding to one of codes of the raw materials;
An order management system, provided in the device for catering preparation or connected to both of the cloud platform and the device for catering preparation, for receiving orders that include a beverage or a food name and a quantity,
wherein the order management system corresponds the beverage name or the food name in the order to the codes and quantities of the raw materials required, and distributes the codes and the quantities of the raw materials to the device for catering preparation, and wherein the device for catering preparation sequentially drives each of the driving devices of the material bins corresponding to one of the codes of the raw materials and dispenses the corresponding quantity of raw material.

15. The system for catering preparation according to claim 14, wherein the cloud platform comprises a recipe management database for being input the names of the beverages or foods and corresponding recipes, and wherein each of the recipes comprises codes and quantities of the raw materials required.
